(19) United States
(12) Patent Application Publication
(10) Pub. No.: US 2022/0069569 A1
(43) Pub. Date: Mar. 3, 2022

(54) MOTOR VEHICLE CIRCUIT PROTECTION DEVICE AND MOTOR VEHICLE CIRCUIT INCLUDING THE SAME

(71) Applicant: JUTE INDUSTRIAL CO., LTD., Taichung (TW)

(72) Inventors: CHE-HUNG LIN, TAICHUNG (TW); CHIA-CHUN YU, TAICHUNG (TW)

(21) Appl. No.: 17/003,672

(22) Filed: Aug. 26, 2020

(51) Int. Cl. H02H 9/04; H05B 47/24

(52) U.S. Cl. CPC H02H 9/04; H05B 47/24

(57) ABSTRACT

A motor vehicle circuit protection device configured to be electrically connected with a power end and a load end is provided, including: a voltage pre-stabilizing unit, set with a maximum voltage value; and a trickle discharge unit, electrically connected with the voltage pre-stabilizing unit, the trickle discharge unit being configured to absorb, obviate or eliminate trickle current from the load end. A motor vehicle circuit includes the motor vehicle circuit protection device is provided, further including the power end and the load end.

### BACKGROUND OF THE INVENTION

### Field of the Invention

The present invention relates to a motor vehicle circuit protection device and motor vehicle circuit including the same.

### Description of the Prior Art

There is often problem of leaking electric current to electric elements of a vehicle such as circuits, switches or batteries due to improper operation, short circuit or excessive moisture in the environment, which can cause non-intentional weak light of headlight or a little non-intentional rotation of motor. Conventionally, a plurality of resistors are applied to electric elements or circuits to improve the problem of leaking electric current. However, the plurality of resistors can result in problem of high heat generation, high cost and large volume.

The present invention is, therefore, arisen to obviate or at least mitigate the above-mentioned disadvantages.

### SUMMARY OF THE INVENTION

The main object of the present invention is to provide a motor vehicle circuit protection device which can prevent trickle current, is sized to be small, can stabilize voltage, and can reduce heat generation.

To achieve the above and other objects, the present invention provides a motor vehicle circuit protection device, configured to be electrically connected with a power end and a load end, including: a voltage pre-stabilizing unit, set with a maximum voltage value; and a trickle discharge unit, electrically connected with the voltage pre-stabilizing unit, the trickle discharge unit being configured to absorb trickle current from the power end.

To achieve the above and other objects, the present invention further provides a motor vehicle circuit, including the aforementioned motor vehicle circuit protection device, and further including the power end and the load unit, where the load unit includes the load end and the motor vehicle circuit protection device.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are structural relationship block diagrams of a motor vehicle circuit having a protection device according to a preferable embodiment of the present invention.

### DETAILED DESCRIPTION OF THE PREFERRED EMBODIMENTS

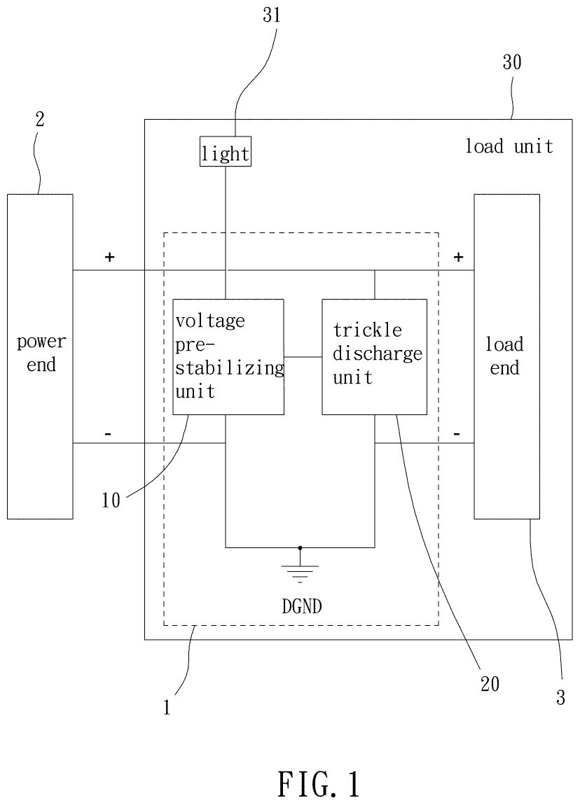

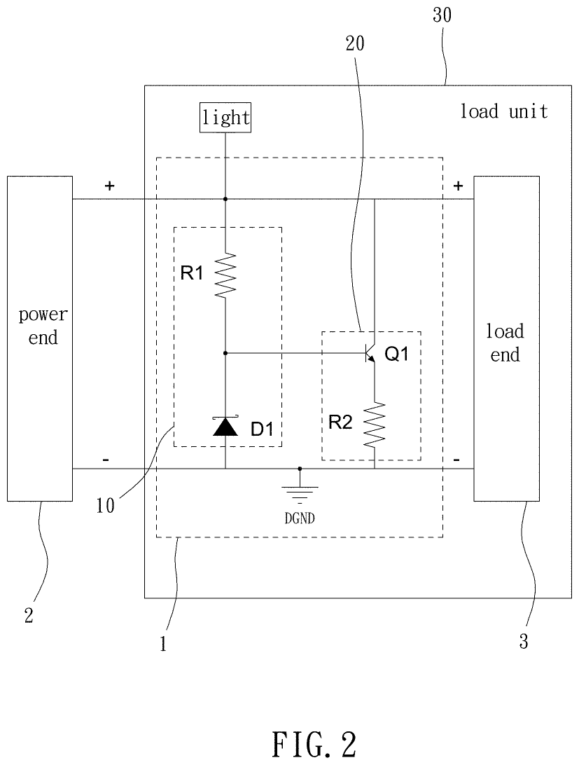

Please refer to FIGS. 1 to 2 for a preferable embodiment of the present invention. A motor vehicle circuit protection device 1 of the present invention is configured to be electrically connected with a power end 2 and a load end 3. The motor vehicle circuit protection device 1 includes a voltage pre-stabilizing unit 10 and a trickle discharge unit 20.

The voltage pre-stabilizing unit 10 is set with a maximum voltage value, wherein the maximum voltage value may be adjustable according to various requirements. The trickle discharge unit 20 is electrically connected with the voltage pre-stabilizing unit 10, and the trickle discharge unit 20 is configured to absorb, obviate or eliminate unexpected trickle current (such as leaking current) from the power end 2. The voltage pre-stabilizing unit 10 limits the voltage of the trickle discharge unit 20 to be equal to or less than the voltage value (V), and thus any power end of higher voltage may be optionally chosen. For example, if the maximum voltage value is 5V, the voltage value of 12V form the power end 2 is lowered to be 5V and then be supplied to the trickle discharge unit 20 so the electric current from the power end 2 can be sufficiently obviated or eliminated. Whereby, it can prevent trickle current, is sized to be small, can stabilize voltage, and can reduce heat generation.

The trickle discharge unit 20 includes a transistor Q1, and the transistor Q1 is a bipolar junction transistor (BJT) or metal-oxide semiconductor field-effect transistor (MOSFET). Preferably, the transistor Q1 is a bipolar junction transistor (BJT) which has preferred voltage and current level. The voltage pre-stabilizing unit 10 includes a zener diode D1 or a voltage regulator, or the voltage pre-stabilizing unit 10 may include a switch or any reference voltage level generating circuit. Preferably, the voltage pre-stabilizing unit 10 includes the zener diode D1, an end of the zener diode D1 is electrically connected with an positive pole (VIN_N) of the power end 2 and a base of the transistor Q1, and another end of the zener diode D1 is electrically connected with a negative pole of the power end 2 and an emitter of the transistor Q1.

The voltage pre-stabilizing unit 10 further includes a first resistor R1, the first resistor R1 and the zener diode D1 are electrically connected in series, and the base of the transistor Q1 is electrically connected between the first resistor R1 and the zener diode D1. Specifically, a positive pole of the zener diode D1 is electrically between the power end 2 and the load end 3, and a negative pole of the zener diode D1 is electrically with the first resistor R1 and the base of the transistor Q1.

The trickle discharge unit 20 further includes a second resistor R2 electrically connected with the transistor Q1, an end of the second resistor R2 is electrically connected with the zener diode D1 and configured to be electrically connected with a negative pole of the load end 3, and another end of the second resistor R2 is electrically connected with the emitter of the transistor Q1. The transistor Q1 can absorb, obviate or eliminate the trickle current from the power end 2 and the second resistor R2 can absorb, obviate or eliminate the trickle current from the power end 2, and the voltage pre-stabilizing unit 10 limits the voltage of the second resistor R2 to be less than the voltage value (V). Whereby, the first resistor R1 can be used to divided voltage and the trickle discharge unit 20 is conducted under a trickle-current state. The resistor of the voltage pre-stabilizing unit 10 may be chosen according to various requirements. That is, at least one of the voltage and resistance of the present invention may be chosen according to various requirements, which provides good obviation and/or elimination of trickle current. The second resistor R2 is configured to absorb, obviate or eliminate the trickle current from the power end 2, and the voltage pre-stabilizing unit 10 limits the voltage of the second resistor R2 to be less than the voltage value (V).

The trickle discharge unit 20 and the voltage pre-stabilizing unit 10 are electrically grounded at a point (DGND). In this embodiment, the point (DGND) is electrically connected between the second resistor R2 and the zener diode D1. Specifically, the transistor Q1 and the zener diode D1 are electrically grounded at the point (DGND) therebetween, thus balancing the voltages of the trickle discharge unit 20 and the voltage pre-stabilizing unit 10. The present invention further provides a motor vehicle circuit including the motor vehicle circuit protection device 1 and further including the power end 2 and a load unit 30. The load unit 30 may be a vehicle lamp or driving device (such as motor). The load unit 30 includes the load end 3 and the motor vehicle circuit protection device 1. The load unit 30 further includes at least one light 31, and the at least one light 31 is electrically connected with one of the voltage pre-stabilizing unit 10 and the trickle discharge unit 20. In this embodiment, the light 31 is electrically connected with the voltage pre-stabilizing unit 10. In an alternative embodiment, the load unit may include two said lights including a high beam light and a low beam light which are electrically connected with the voltage pre-stabilizing unit and the trickle discharge unit, respectively. The two said lights may be both high beam lights or both low beam lights.

The load end 3 may be a circuit board of a vehicle lamp, motor, power unit or the like. The power end 2 may be a battery.

Give the above, the trickle current from the power end is conducted to the trickle discharge unit and absorbed, obviated and/or eliminated by the trickle discharge unit, thus preventing trickle current.

Although particular embodiments of the invention have been described in detail for purposes of illustration, various modifications and enhancements may be made without departing from the spirit and scope of the invention. Accordingly, the invention is not to be limited except as by the appended claims.

1. A motor vehicle circuit protection device, configured to be electrically connected with a power end and a load end, including:
a voltage pre-stabilizing unit, set with a maximum voltage value; and
a trickle discharge unit, electrically connected with the voltage pre-stabilizing unit, the trickle discharge unit being configured to absorb trickle current from the power end;
wherein the voltage pre-stabilizing unit limits the voltage of the trickle discharge unit to be equal to or less than the voltage value;
wherein the trickle discharge unit includes a transistor;
wherein the voltage pre-stabilizing unit includes a zener diode, an end of the zener diode is electrically connected with a positive pole of the power end, a positive pole of the load end and a base of the transistor, and another end of the zener diode is electrically grounded and electrically connected with a negative pole of the power end, a negative pole of the load end and an emitter of the transistor;
wherein the voltage pre-stabilizing unit further includes a first resistor, the first resistor and the zener diode are electrically connected in series, and the base of the transistor is electrically connected between the first resistor and the zener diode;
wherein the trickle discharge unit further includes a second resistor electrically connected with the transistor, an end of the second resistor is electrically connected with the zener diode, electrically grounded and configured to be electrically connected with a positive pole of the power end and the negative pole of the load end, another end of the second resistor is electrically connected with the emitter of the transistor; the trickle discharge unit and the voltage pre-stabilizing unit are electrically grounded at a point therebetween;
the second resistor and the zener diode are electrically grounded at a point therebetween;
and the second resistor is configured to absorb the trickle current from the power end, and the voltage pre-stabilizing unit limits the voltage of the second resistor to be less than the voltage value.

2. (canceled)

3. The motor vehicle circuit protection device of claim 1, wherein the transistor is a bipolar junction transistor (BJT) or metal-oxide semiconductor field-effect transistor (MOSFET).

4. (canceled)

5. (canceled)

6. (canceled)

7. (canceled)

8. The motor vehicle circuit protection device of claim 1, wherein the transistor is a bipolar junction transistor; a positive pole of the zener diode is electrically between the power end and the load end and a negative pole of the zener diode is electrically with the first resistor and the base of the transistor.

9. A motor vehicle circuit, including the motor vehicle circuit protection device of claim 1, and further including the power end and the load unit, where the load unit includes the load end and the motor vehicle circuit protection device.

10. The motor vehicle circuit of claim 9, wherein the load unit further includes at least one light, the at least one light is electrically connected with one of the voltage pre-stabilizing unit and the trickle discharge unit.
